(19) United States
(12) Patent Application Publication
(10) Pub. No.: US 2009/0194175 A1
(43) Pub. Date: Aug. 6, 2009

(54) SHUT-OFF DEVICE AND PROCESS FOR PRODUCING A SHUT-OFF DEVICE

(76) Inventors: Metin Gerceker, Neusaess (DE); Martin Hock, Munchen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/718,114

(22) PCT Filed: Sep. 27, 2005
(86) PCT No.: PCT/EP05/10432

§ 371 Date: Mar. 24, 2009

(30) Foreign Application Priority Data
Oct. 29, 2004 (DE) 10 2004 052 962.0

(51) Int. Cl. F15C 3/00; C21D 6/04

(52) U.S. Cl. 137/561 R; 148/577

(57) ABSTRACT

The invention relates to a shut-off device (1) and a process for producing a shut-off device with a housing (2) and a shut-off flap (3) that is pivotally located in the housing, a shut-off flap seat (7) formed by the components (2; 3; 8, 12a; 12b) being located between the housing (2) and the shut-off flap (3). To achieve the object of ensuring a good fit and thus a high level of tightness of the shut-off device, it is suggested according to the invention that the components (2; 3; 8, 12a; 12b) of the shut-off device (1) that form the shut-off flap seat (7) are subjected to treatment by cold ageing in the low temperature range. This treatment by cold ageing takes place advantageously before final mechanical working of the components (2; 3; 8, 12a; 12b) with liquid nitrogen.

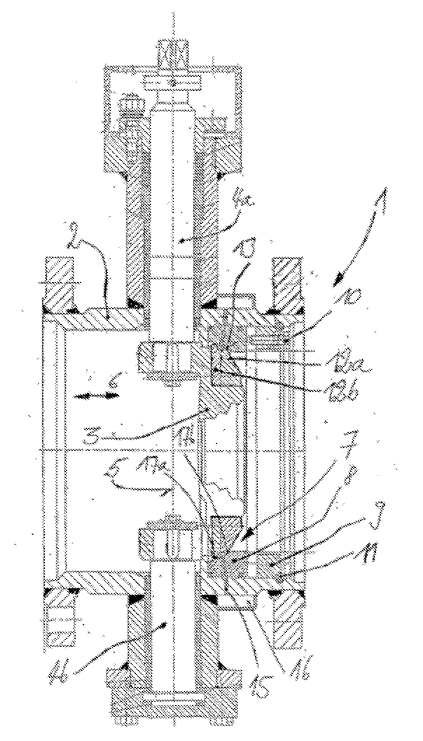

The invention relates to a shut-off device, especially a shut-off device for operating temperatures below 0° C., with a housing and a shut-off flap pivotally located in the housing, between the housing and the shut-off flap there being a shut-off flap seat that is formed by components.

The invention furthermore relates to a process for the production of a shut-off device, especially a shut-off device for operating temperatures below 0° C.

In such shut-off devices that are used in operation at operating temperatures below 0° C., the components that form the shut-off flap seat that is located between a housing and a shut-off flap are produced from CrNi steel. Such austenitic steels, however, have an unstable structure in the low temperature range, partial conversion from austenite into martensite taking place. The proportion of convertible austenite is dependent here on the alloy composition. This structural change is associated with an increase in volume. For shut-off devices that are used in the low temperature range, therefore in the operation of the shut-off device on the components that form the shut-off flap seat, due to the unstable structure of the components of the shut-off flap seat that consist of CrNi steel, a structural change from austenite into martensite can occur, by which the volume increases on the components that form the shut-off flap seat. This increase in volume, however, leads to a change in the shape of the components, which can lead to a reduction of the fitting precision of the shut-off flap seat and thus to a reduced tightness of the shut-off device.

The object of this invention is to make available a shut-off device of the aforementioned type and a process for producing a generic shut-off device in which a good fit and thus a high level of tightness of the shut-off flap seat in the operation of the shut-off device can be ensured.

This object is achieved according to the invention with respect to the shut-off device in that the components of the shut-off device that form the shut-off flap seat are subjected to treatment by cold ageing in the low temperature range. Cold ageing in the low temperature range of the components of the shut-off device that form the shut-off flap seat according to the invention during production of the shut-off device results in that a structural change from austenite into martensite takes place. In the operation of the shut-off device, especially at operating temperatures below 0° C., the structural change from austenite into martensite on the components of the shut-off device that form the shut-off flap seat can thus be avoided, by which in the operation of the shut-off device, high stability of shape of the components that form the shut-off flap seat and thus a good fit of the shut-off flap seat and therefore a high level of tightness of the shut-off device can be ensured. Treatment according to the invention by cold ageing in the low temperature range of the components that form the shut-off flap seat furthermore increases the hardness and strength of the components due to the increased martensite content, by which in addition increased wear resistance of the shut-off flap seat and thus a prolonged service life of the shut-off flap seat can be achieved.

According to one further development of the invention, treatment takes place especially advantageously by cold ageing of the components that form the shut-off flap seat before final mechanical working of the components. This results in that the structural change on these components is almost completely finished by the cold ageing according to the invention before final working of the components of the shut-off flap seat, by which after final working, for example a turning or grinding process, high stability of shape and thus a good fit of the components of the shut-off flap seat in the operation of the shut-off device can be ensured.

Cold ageing of components can take place by means of various media. Special advantages arise when cold ageing of components takes place by means of liquid nitrogen. With liquid nitrogen, cold ageing down to a temperature of −196° C. can be done, by which cold ageing can be achieved at low temperatures at economical costs.

To the extent cold ageing of components takes place in a liquid nitrogen bath, cold ageing can be done especially advantageously at temperatures down to −196° C. Cold ageing of components can proceed in this connection in a correspondingly suited chest freezer, an upright freezer or a freezing tunnel.

Advantageously, the components of the shut-off device that comprise the shut-off flap seat consist of CrNi steel. In such austenitic stainless steels, by treatment by cold ageing in liquid nitrogen, conversion of the austenite into martensite can be achieved at low cost, and thus high stability of shape of the components of the shut-off flap seat can be achieved.

The shut-off flap seat can be made according to one advantageous configuration of the invention in this connection between the shut-off flap or at least one component that is located on the shut-off flap and the housing or at least one component that is located on the housing. In a configuration of the shut-off flap seat directly on the shut-off flap and the housing, the number of parts of the shut-off device is small. In a configuration of the shut-off flap seat on a component connected to the shut-off flap and/or a component located on the housing, the shut-off flap seat can be made on compact components that can be easily subjected to the treatment according to the invention and subsequent final mechanical working.

The aforementioned object is achieved with respect to the process for producing a shut-off device, especially a shut-off device for operating temperatures below 0° C., of the initially named type, such that before final mechanical working of the components made of CrNi steel that form the shut-off flap seat, treatment of the components by cold ageing in the low temperature range is done and the components after cold ageing are heated to ambient temperature. With such a process, it is easily possible to complete the structural change from austenite into martensite before final mechanical working in the components of the shut-off device that form the shut-off flap seat, so that the components of the shut-off flap seat after final mechanical working have high stability of shape and thus the shut-off flap seat has a good fit and the shut-off device has a high level of tightness in operation.

Heating to the ambient temperature of the components is done especially advantageously without a heating device. Thus, an additional heating means is not necessary for reheating the components, yielding an economical treatment process.

Cold ageing in the low temperature range and subsequent heating to the ambient temperature according to one preferred further development of the invention are done especially advantageously several times in succession, especially twice to four times, preferably three times. By repeating the cold ageing according to the invention in the low temperature range of the components that form the shut-off flap seat several times, the residual content of convertible austenite of the components can be further reduced, its having been shown that for triple cold ageing in the low temperature range and subsequent heating to the ambient temperature each time in the components of the shut-off flap seat, the convertible austenite proportion is almost completely converted into martensite and thus the structural change is completed.

Other advantages and details of the invention are explained in more detail using the embodiment shown in the schematic.

The FIGURE shows a shut-off device 1 according to the invention made, for example, as a double cam shut-off flap in a lengthwise section. The shut-off device 1 has a housing 2 in which a shut-off flap 3 is supported to be able to turn double-eccentrically. The figure shows the shut-off flap 3 in the blocked position. The shut-off flap 3 is mounted to be able to turn around an axis 5 of rotation by means of a split drive shaft 4a, 4b. In the opened position, the medium can flow through the shut-off device 1 in the flow-through direction 6.

The shut-off device 1 has a shut-off flap seat 7 that is made between the housing 2 and the shut-off flap 3.

The shut-off flap seat 7 is made on a component 8 that is braced with the housing 2 via a fastening ring 9, a holding means 11 and several fastening screws 10, and two components 12a, 12b that are attached to the shut-off flap 3.

The component 8 is made as a metal ring that is provided with a conical seat surface 13 that tapers to the inside. The components 12a, 12b are made as metal rings that are spaced in the axial direction of the shut-off device 1. Each component 12a, 12b is provided in the region of the seat surface 13 with a sealing surface 17a, 17b that interacts with the seat surface 13 and that has, for example, a circular cross-section.

Between the components 12a, 12b, an annulus is formed that is connected via a connecting hole 15 that is made in the component 8 and the housing 2 to a space 16 that is provided with connections for a blocking medium or flushing medium.

According to the invention, the components 12a, 12b and the component 8 that together form the shut-off flap seat 7, before final mechanical working, for example a turning or grinding process for producing the seat surface 13 and the sealing surface 17a or 17b, are subjected to treatment by at least one-time cold ageing in liquid nitrogen and subsequent heating to ambient temperature. This treatment results in that the convertible austenite proportion in components 8, 12a, 12b before final mechanical working is converted into martensite. The structural change of the convertible austenite proportion present in the components 8, 12a, 12b into martensite with the associated volume increase thus occurs before final mechanical working of the components 8, 12a, 12b. After final mechanical working of components 8, 12a, 12b in which the seat surface 13 and the sealing surface 17a or 17b are produced, a further structural change and therefore a volume increase can thus be almost completely avoided on the components 8, 12a, 12b that form the shut-off flap seat 7 in the operation of the shut-off device 1.

In the operation of the shut-off device under low temperature conditions, a structural change from austenite into martensite with a corresponding increase in volume in the components 8, 12a, 12b is thus avoided. In the operation of the shut-off device 1, this yields high stability of shape of the components 8, 12a, 12b that form the shut-off flap seat 7 and thus a good fit of the shut-off flap seat 7, by which the shut-off device 1 has a high level of tightness in operation.

It is, of course, possible, instead of the two components 12a, 12b, to provide one component 12 that is provided with one sealing surface 17 or several sealing surfaces 17a, 17b, on the shut-off flap 3. Moreover, it is possible to form the shut-off flap seat 7 directly between the housing 2 and the shut-off flap 3 without additional components 8, 12a, 12b, the sealing surface 17 being formed on the outer periphery of the shut-off flap 3 and the seat surface 13 being formed on the inner periphery of the housing 2 and thus the housing 2 and the shut-off flap 3 constituting the components that form the shut-off flap seat 7. Moreover, it is possible to provide—only on the shut-off flap 3—one component 12 or several components 12a, 12b on which at least one sealing surface 17 at a time is formed, and to make the seat surface 13 directly on the housing 2, by which the component 12 or the components 12a, 12b and the housing 2 constitute the components that form the shut-off flap seat 7, or to make the sealing surface 17 directly on the shut-off flap 3 and, on the housing 2, to provide a component 8 with the seat surface 13, by which the shut-off flap 3 and the component 8 constitute the components that form the shut-off flap seat 7.

1. In a shut-off device, especially a shut-off device for operating temperatures below 0° C., comprising a housing (2) and a shut-off flap (3) pivotally located in the housing, and between the housing and the shut-off flap there being a shut-off flap seat (7) that is formed by components, the improvement wherein the components (2; 3; 8, 12a; 12b) of the shut-off device (1) that form the shut-off flap seat (7) have been subjected to treatment by cold ageing in the low temperature range.

2. A shut-off device according to claim 1, wherein said treatment cold ageing was conducted before final mechanical working of the components (2; 3; 8, 12a; 12b).

3. A shut-off device according to claim 1, wherein the components (2; 3; 8, 12a; 12b) were cold-aged by means of liquid nitrogen.

4. A shut-off device according to claim 3, wherein the components (2; 3; 8, 12a; 12b) were cold-aged in a liquid nitrogen bath.

5. A shut-off device according to claim 1, wherein the components (2; 3; 8, 12a; 12b) consist of CrNi steel.

6. A shut-off device according to claim 1, wherein the shut-off flap seat (7) is disposed between the shut-off flap (3) or at least one component (12a; 12b) that is located on the shut-off flap (3) and the housing (2) or at least one component (8) that is located on the housing (2).

7. A process for producing a shut-off device, especially a shut-off device for operating temperatures below 0° C., according to claim 1, wherein before final mechanical working of the components (2; 3; 8, 12a; 12b) that form the shut-off flap seat (7), treating the components (2; 3; 8, 12a; 12b) by cold ageing in the low temperature range, done and heating the components (2; 3; 8, 12a; 12b) to the ambient temperature after cold ageing.

8. A process according to claim 7, wherein heating to the ambient temperature of the components (2; 3; 8, 12a; 12b) is done without a heating means.

9. A process according to claim 7, wherein cold ageing in the low temperature range and subsequent heating to ambient temperature constitutes a cycle and is carried out several times in succession.

10. A process according to claim 9, wherein the cycle is conducted 2-4 times.

11. A process according to claim 9, wherein the cycle is conducted 3 times.

12. A shut-off device prepared according to claim 7.

13. A process according to claim 10, wherein the cycle is conducted 3 times.

14. A process according to claim 11, wherein the cycle is conducted 3 times.
